(19) United States
(12) Patent Application Publication
(10) Pub. No.: US 2008/0173807 A1
(43) Pub. Date: Jul. 24, 2008

(54) Fragmentation modulation mass spectrometry

(76) Inventors: Oh-Kyu Yoon, Stanford, CA (US); Richard N. Zare, Stanford, CA (US)

Correspondence Address: LUMEN PATENT FIRM, INC., 2345 YALE STREET, SECOND FLOOR, PALO ALTO, CA, 94306, US

(21) Appl. No.: 11/786,434

(22) Filed: Apr. 10, 2007

Related U.S. Application Data
(60) Provisional application No. 60/791,387, filed on Apr. 11, 2006.

(51) Int. Cl. B01D 59/44

(52) U.S. Cl. 250/282; 250/287

(57) ABSTRACT

Improved mass spectrometry is provided by modulating the fragmentation efficiency of analyte ions according to a modulation input signal. The fragmentation modulated ions are then analyzed according to time of flight and according to either ion kinetic energy or ion momentum to provide measured data. A mathematical inversion corresponding to the modulation input is applied to the measured data along the time axis to deconvolute the effect of the modulation input signal on the data, thereby providing 2-D data for time of flight vs. energy/momentum for precursor ions and fragment ions simultaneously. After the dissociation, the ion velocity remains almost unchanged, but the kinetic energy or momentum is partitioned amongst the fragments. Thus, the time of flight and energy/momentum can be converted to precursor mass and fragment mass to obtain 2-D spectrum of fragments vs. their corresponding precursors. The resulting technique can be referred to as fragmentation modulation mass spectrometry (FMMS). Enhanced sensitivity is derived from high duty-cycle ion fragmentation modulation, information about the masses of precursor ions comes from the times of flight, and information about the masses of fragment ions is obtained from the modulated fragmentation and energy/momentum analysis.

### CROSS REFERENCE TO RELATED APPLICATIONS

This application claims the benefit of U.S. provisional patent application 60/791,387, filed on Apr. 11, 2006, entitled “Fragmentation Modulation Mass Spectrometry”, and hereby incorporated by reference in its entirety.

### GOVERNMENT SPONSORSHIP

This invention was made with Government support under grant number FA9550-04-1-0076 from AFOSR. The Government has certain rights in this invention.

### FIELD OF THE INVENTION

This invention relates to mass spectrometry.

### BACKGROUND

Mass spectrometry (MS) is an analytical technique based on distinguishing ions based on differences in ion mass. Analyte ions can be passed through an ion separator where they follow mass-dependent trajectories subject to known electric or magnetic fields, thus their mass-to-charge ratios can be measured. There are many different types of mass spectrometers depending on the method of ion separation. Magnetic sector mass spectrometer is historically the most important, which is based on ion separation according to ion momentum (magnetic separator). Most common are quadrupole or ion trap mass spectrometers based on mass-dependent stability of ion trajectories under radio-frequency electric fields. Fourier transform mass spectrometer is based on the mass-dependent frequency of ion cyclotron motion in constant magnetic field and offers the highest mass resolution. The simplest is the time-of-flight mass spectrometer, where the ion flight time over a fixed distance is used to determine the mass. Mass spectrometry possesses the advantages of rapid data acquisition, sensitivity, large dynamic range, and selectivity. Hadamard transform time of flight mass spectrometry is a high duty-cycle variant of time-of-flight mass spectrometry and is considered in U.S. Pat. No. 6,300,626 and U.S. Pat. No. 6,870,157, where on-off beam modulation is employed to increase duty cycle.

However, some ion mixtures are difficult to resolve with conventional mass spectrometry. Such mixtures may contain isomers, measurement precision may not suffice to resolve different ion masses, or the molecular mass may be insufficient to identify the complex chemical structure of the analytes. Tandem mass spectrometry, also known as MS/MS, has been developed to address such situations, e.g., as considered in U.S. Pat. No. 4,952,803 and U.S. Pat. No. 4,234,791. In MS/MS, the general strategy is to select ions within a narrow mass to charge window, dissociate these ions in a reproducible manner, and measure the molecular weights of the resulting fragment ions. Triple quadrupole (QqQ), multiple sector (BEEB), multiple TOF analyzers (TOF-TOF), and hybrid mass spectrometers (Q-TOF, BEqQ) are examples of tandem-in-space MS/MS instruments, where two or more mass spectrometers are used in tandem. Ion storage devices (ion trap and FTMS) are tandem-in-time instruments, where the same mass spectrometer is used sequentially in time. Although MS/MS is a powerful analysis technique, it tends to be time-consuming, because each parent ion species is typically selected, fragmented and analyzed sequentially. Rapid analysis time is more important in high throughput applications or kinetics studies where multiple analytes have to be analyzed simultaneously as a function of time.

Attempts have been made to improve the speed of MS/MS techniques. For example, U.S. Pat. No. 6,770,871 considers a tandem mass spectrometer where the second mass analyzer is a TOF analyzer, to provide high speed full spectrum fragment data. In U.S. Pat. No. 4,472,631, measurement speed is increased by omitting the parent selection step of conventional MS/MS. Instead, the input beam of analyte ions is pulsed, fragmented, passed through an ion separator, and then detected to provide time of flight and spatial separation for the fragmented ion beam simultaneously. However, pulsing the ion beam undesirably reduces duty cycle, which tends to decrease instrument sensitivity.

Accordingly, it would be an advance in the art to provide simultaneous time of flight and spatial separation mass spectrometry of ion parents and ion fragments having improved duty cycle.

### SUMMARY

Improved mass spectrometry is provided by modulating the fragmentation efficiency of analyte ions according to a modulation input signal. The fragmentation modulated ions are then analyzed according to time of flight and according to either ion kinetic energy or ion momentum to provide measured data. A mathematical inversion corresponding to the modulation input is applied to the measured data along the time axis to deconvolute the effect of the modulation input signal on the data, thereby providing 2-D data for time of flight vs. energy/momentum for precursor ions and fragment ions simultaneously. After the dissociation, the ion velocity remains almost unchanged, but the kinetic energy or momentum is partitioned amongst the fragments. Thus, the time of flight and energy/momentum can be converted to precursor mass and fragment mass to obtain a 2-D spectrum of fragments vs. their corresponding precursors. The resulting technique can be referred to as fragmentation modulation mass spectrometry (FMMS).

Enhanced sensitivity is derived from high duty-cycle ion fragmentation modulation, information about the masses of precursor ions comes from the times of flight, and information about the masses of fragment ions is obtained from the modulated fragmentation and energy/momentum analysis.

The modulation of the fragmentation process performs multiple functions:

(1) Simultaneous analysis of all analytes: In MS/MS, precursor ion selection is usually required because, otherwise, the complexity of mass spectra prevents their interpretation. In FMMS, the mass information is obtained through the modulation and demodulation scheme and time and energy/momentum analysis. Thus, multiple analytes can be analyzed simultaneously.
(2) Increased efficiency of detection of product ions: This increase is a consequence of the fact that thousands of ion packets can be fragmented within a single sequence period. For modulation with a Hadamard sequence, for example, the efficiency is enhanced N/2 times, where N is the length of the sequence employed (typically N is on the order of 2¹⁰−1 =1023).
(3) No need for double mass analysis or double modulation: In MS/MS, ion species of a narrow mass range must be selected in a mass spectrometer, following which they are fragmented, and the product ions must be mass analyzed in a second mass spectrometer. Thus, two mass spectrometers are usually required. In ion trap mass spectrometers, the same mass spectrometer is used sequentially. Another method of using one mass spectrometer to measure the masses of the precursor and product ions is to modulate both the ion beam and the fragmentation process. However, this requires careful synchronization of the two modulations and could suffer from artifact peaks produced from imperfect or mismatched modulations. In FMMS, only the fragmentation process is modulated, but the same information as in MS/MS or double modulation is obtained through kinetic energy/momentum analysis of the product ions.
(4) Definition of the time zero of the flight time: In conventional TOFMS, either creation or extraction of an ion packet defines the time zero. In FMMS, however, the ion beam is continuous and the start of every modulation period defines the zero point. For modulation with a Hadamard sequence, for example, the recorded detector signal along the time axis will be the Hadamard sequence with a phase shift that depends on the mass of the precursor ions.

Analytical advantages of FMMS include the simultaneous MS/MS analysis of all ionizable analytes in a mixture and real-time analysis, rather than the quench flow or pump-probe type approach. These advantages are relevant for several application areas that require monitoring of all analytes in time-dependent processes. The MS/MS information can be used to gain structural information and distinguish isomers and the real-time analysis allows the analysis of less stable intermediates. Kinetics provide valuable insights in studying reaction mechanism from simple organic reactions to complex biological reactions. FMMS can be used for following reaction profiles of time-dependent processes in real time by looking at the MS/MS spectra of all analytes. FMMS would also provide a rapid detection scheme for imaging analysis where ion mixtures are generated by scanning a laser beam across a surface.

Specific applications of FMMS include, but are not limited to:

(1) Combustion and atmospheric chemistry: Because FMMS allows for high sensitivity and rapid spectral acquisition, the technique can be applied to combustion analysis and time-dependent species detection.

(2) FMMS imaging: FMMS can provide a rapid detection scheme for imaging analysis where ion mixtures are generated by scanning a laser beam across a surface. This method could be applied to studying organic deposits on metals or direct analysis of the degradation of polymers.

(3) Study of non-covalent interactions between biomolecules: Non-covalent interactions between biomolecules including proteins, peptides, and DNA are very important in cells. FMMS can be used to study multiple interactions by using softer ionization and fragmentation methods. Intact non-covalently bound biomolecules can be disrupted by modulating the soft fragmentation to study their interactions.

### BRIEF DESCRIPTION OF THE DRAWINGS

FIG. 1 shows a mass spectrometry system according to an embodiment of the invention.

FIG. 2 shows an ion fragmentation apparatus suitable for use in embodiments of the invention.

FIG. 3 shows another ion fragmentation apparatus suitable for use in embodiments of the invention.

FIG. 4 shows yet another ion fragmentation apparatus suitable for use in embodiments of the invention.

FIG. 5 is a schematic representation of time of flight vs. kinetic energy data provided by an embodiment of the invention.

FIG. 6 is a simulation of time of flight vs. kinetic energy data provided by an embodiment of the invention.

FIGS. 7a-b shows precursor and fragment mass spectra corresponding to the example of FIG. 6.

FIG. 8 shows a method for inferring ion kinetic energy information from time of flight measurements.

### DETAILED DESCRIPTION

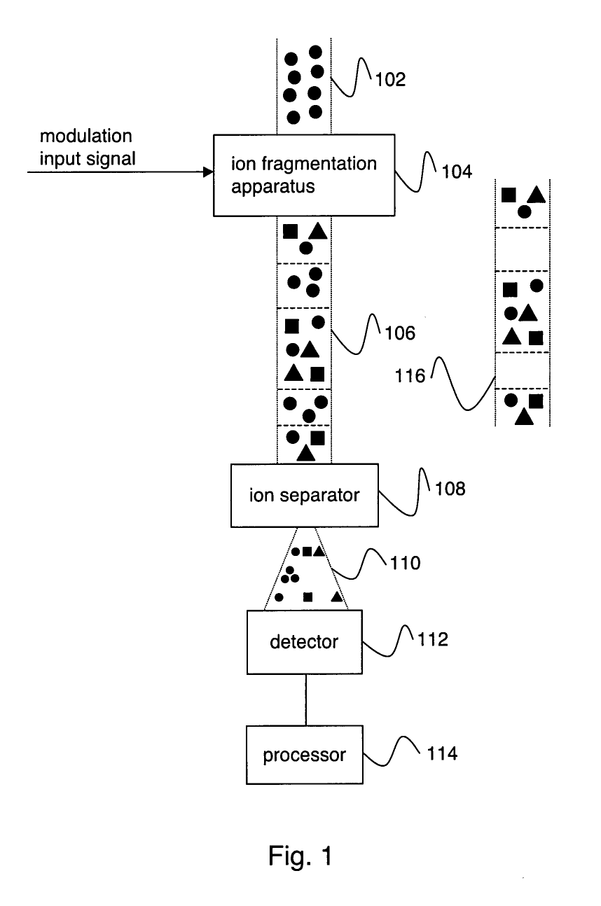

FIG. 1 shows a mass spectrometry system according to an embodiment of the invention. A substantially continuous beam of analyte ions 102 is received by an ion fragmentation apparatus 104, which also receives a beam modulation input signal. Within ion fragmentation apparatus 104, input analyte ions are decomposed into fragments. The efficiency of this decomposition varies in time according to the beam modulation input signal. As a result, beam modulation apparatus 104 produces a fragmentation modulated ion beam 106. The example of FIG. 1 shows binary fragmentation modulation. For some time intervals, beam 106 is substantially un-fragmented (all circles), and for other time intervals, beam 106 is partially fragmented (circles, square and triangles). Here the circles represent precursors (i.e., parent ions), and the squares and triangles represent fragments (i.e., daughter ions).

The fragmentation modulated beam 106 is received by an ion separator 108, which separates ions according to ion time of flight and according to either ion kinetic energy or ion momentum to provide a dispersed ion beam 110. An electrostatic analyzer can be used to provide ion separation according to kinetic energy, and a magnetic analyzer can be used to provide ion separation according to ion momentum. Preferably, focusing of ion beam angular distribution is provided. Suitable electric and magnetic ion separators for practicing the invention are well known in the art, as are suitable ion beam angular focusing arrangements.

Dispersed ion beam 110 is received by a detector 112 to provide a modulated ion spectrum. Detector 112 is preferably a high resolution 2-D imaging and timing detector for charged particles. Suitable detectors are known in the art, e.g., multichannel plate detectors having delay-line anodes. The output of detector 112 is received by a processor 114, where a mathematical inversion corresponding to the beam modulation input signal is performed to provide a measured ion spectrum. Methods for performing such inversions are known in the art, e.g., in connection with Hadamard transform time of flight mass spectrometry (HT-TOFMS) as described in U.S. Pat. No. 6,300,626. It is important that the modulation input signal be selected such that a corresponding mathematical inversion exists, but the invention can be practiced with any such modulation input signal. The modulation signal can be discrete (e.g., a Hadamard sequence or any other digital sequence) or analog (e.g., a sinusoid or any other arbitrary continuous waveform).

Provision of a fragmentation modulated ion beam (e.g., 106 on FIG. 1) is a key aspect of the present invention. It is important to distinguish a fragmentation modulated beam according to the present invention (e.g., beam 106 on FIG. 1) from an ion beam that is first modulated, then fragmented. Such an ion beam would appear as shown by 116 on FIG. 1. In beam 106, the decomposition efficiency is modulated, while in beam 116, the beam flux is modulated.

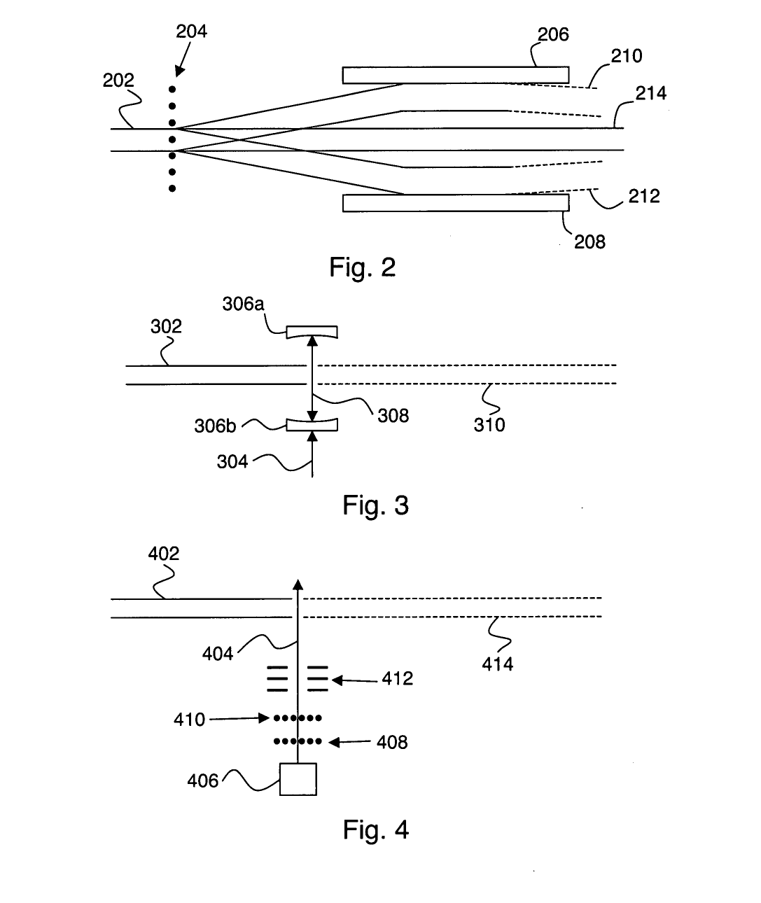

Any method of inducing ion fragmentation that can be modulated with respect to its decomposition efficiency can be employed in practicing the invention. Known methods of ion fragmentation include collisionally induced dissociation (CID), photodissociation (PD), electron-induced dissociation (EID) and surface induced dissociation (SID). Although CID is the most commonly employed method for ion fragmentation in mass spectrometry, it is difficult to modulate the efficiency of CID at the megahertz speeds which are desirable in practicing the invention. However, rapid modulation of SID, PD, and EID dissociation efficiency is feasible, and ion fragmentation apparatus implementations corresponding to these methods are described in connection with FIGS. 2-4.

FIG. 2 shows an ion fragmentation apparatus suitable for use in embodiments of the invention, based on surface induced dissociation (SID). SID involves collision of ions with a solid surface, causing some of the ions to undergo fragmentation. The most commonly used target surfaces are self-assembled monolayers (SAM), having fluorinated alkanethiol monolayers adsorbed on gold mirrors evaporated onto silicon wafers or titanium-coated glass. The fluorinated SAM are known to have the best characteristics, where the last two carbons are fluorinated. These surfaces can convert 10 to 30% of translational energy into internal energy at low kinetic energies of 50-100 eV. Also, SID deposits a narrow distribution of energy into internal energy, which can be tuned easily by changing the collision energy. SID can be modulated at MHz rates by using a Bradbury Nielson Gate (BNG), or other ion gate. An ion gate 204 can deflect an ion beam 202 onto SAM surfaces 206 and 208, where the ions will fragment with a high probability. Thus, by modulating the ion gate at MHz rates, SID can be modulated at the same rate. The fragmented ions (210, 212) will arrive at different positions on the detector from the ions that were not deflected (214), and therefore not fragmented. The ion separation according to kinetic energy/momentum happens perpendicular to the ion gate deflection and can be measured on the 2-D imaging and timing detector.

FIG. 3 shows another ion fragmentation apparatus suitable for use in embodiments of the invention, based on photodissociation (PD). In PD, a narrow and well-defined energy is transferred to precursor ions. The absorbed energy can break bonds in the precursor ions. Control over photon energy and laser power can be useful for studies of dissociation mechanisms. However, the efficiency of PD fragmentation depends strongly on the absorption spectrum of the ions, where a typical cross section is on the order of 10⁻¹⁸ cm². Chromophore selectivity limits the generality of photodissociation, but, when used judiciously, can also simplify the fragmentation spectrum. For example, although peptides do not absorb in the visible or with the UV lines of an Ar ion laser, dinitrophenyl derivatized peptides strongly absorb and fragment, with the charge mostly retained on the N-terminus.

Fragmentation can be described in terms of Beer's law for a dilute absorber I_{ab}=I₀nσl, where I_{ab} is the flux of photons absorbed, I₀ is the initial photon flux, n is the ion number density in the fragmentation zone, σ is the cross section, and l is the path length. Assuming an ion current of 10 pA, an ion beam width of 1 mm, and an ion velocity of 10⁵ m/s, n is 10³ ions/cm³. Using a photodissociation cross section of 5×10⁻¹⁸ cm², nσl is approximately 10⁻¹⁴ for a laser pulse of 200 ns. A modulated laser beam 304 with a peak power of 10 W from a visible multiline Ar ion laser, causes fragmentation of 5×10³ ions of ion beam 302 within 200 ns to provide fragmentation modulated ion beam 310. To increase the fragmentation efficiency, a cavity with two high reflectivity (i.e., 99% or greater) mirrors 306a and 306b can be employed. The intensity of laser light 308 circulating inside the cavity is given by I_{c}=I₀/T, where I_{c} is the circulating laser intensity inside the cavity, I₀ is the incoming laser intensity, and T is the transmission of the mirrors. For 1% transmission mirrors, I is 100 times larger than I₀. Thus, the circulating intensity for this example becomes 1 kW. Any optical resonator geometry having two or more mirrors can be employed in practicing the invention.

The characteristic cavity time τ_{c} is given by τ_{c}=2 L/cT, where L is the cavity length, and c is the speed of light. For a 1.5 cm cavity with 1% transmission mirrors, τ_{c} is 10 ns, which is smaller than a typical modulation bin time of 100 ns or larger. Therefore, if a 9-bit sequence (length 2⁹−1=511) is used, 120 product ions will be detected in 100 μs. If the image is averaged for 5 ms, 6000 fragment ions are detected.

FIG. 4 shows yet another ion fragmentation apparatus suitable for use in embodiments of the invention, based on electron-induced dissociation. In an early report of EID for fragmentation, the observed cross section for cyanobenzene was 6×10⁻¹⁶ cm² at 7.5 eV. A fragmentation efficiency of 85% was observed for exciting gramicidin S for 500 μs using 50 μA 70 eV electron beam. Large energies can be transferred to ions with a broad distribution and the average transferred energy can be easily varied by changing the energy of the bombarding electrons. Thus, EID is not selective and is expected to give a similar fragmentation spectrum as CID. A maximum cross section of 10⁻¹¹ cm² has been reported for electron capture dissociation (ECD) of proteins, where low energy electrons (<0.2 eV) were captured by the proteins leading to bond selective fragmentation at high efficiency.

The example of FIG. 4 shows a cathode 406, an extraction grid 408 for extracting electrons, and an acceleration grid 410 for controlling electron kinetic energy. Electron beam 404 can be modulated by modulating the voltage applied to acceleration grid 410. A one-axis Einzel lens 412 can be employed to focus electron beam 404 to produce an electron sheet beam. Input ion beam 402 is modulated by electron beam 404 to provide fragmentation modulated ion beam 414. Assuming a cross section of 5×10⁻¹⁵ cm², nσl is approximately 10⁻¹¹. For an electron beam current of 1 A, 1.5×10⁵ ions will fragment in 5 ms.

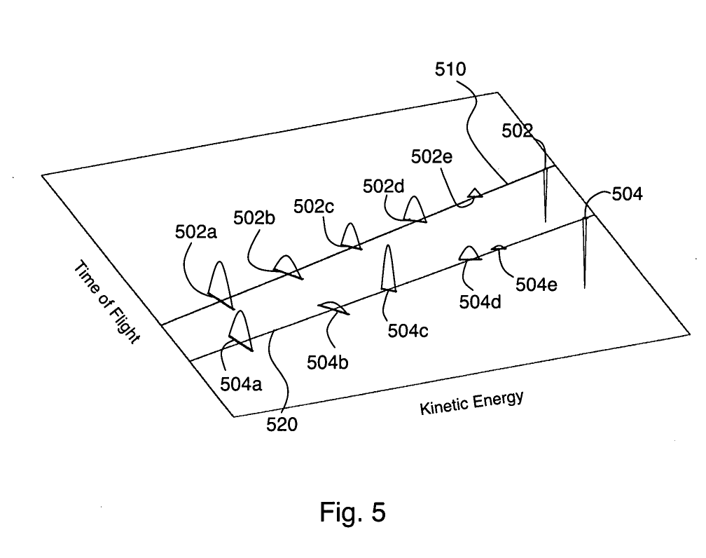

FIG. 5 is a schematic representation of time of flight vs. kinetic energy data provided by an embodiment of the invention. The following analysis provides an explanation of some of the features shown on FIG. 5. If a precursor ion of mass M₁ fragments to a product ion of mass M₂,

M₁⁺→M₂⁺+M₃ (1)

the kinetic energy of M₂ is given by

$$KE ( {M}_{2} ) = \frac{{M}_{2}}{{M}_{1}} KE ( {M}_{1} ) = \frac{{M}_{2}}{{M}_{1}} e {V}_{0} \qquad ( 2 )$$

where eV₀ is the kinetic energy of M₁. The kinetic energies of the product ions are proportional to their masses, but the velocities are almost equal to that of the precursor ion. Thus, the velocities of the product ions contain information about their precursor ion, whereas their kinetic energies can be used to extract the mass of each product ion. The flight times and the kinetic energies of the modulated precursor and product ions are simultaneously measured and analyzed. From these data, a two-dimensional map of the masses of the product ions vs. their corresponding precursor ions can be generated. The time axis is encoded from the modulation of the fragmentation and needs to be deconvoluted to recover the original spectra, which will be obtained with an enhanced signal-to-noise ratio because of the multiplexing advantage.

In a unimolecular decomposition reaction, a small amount of kinetic energy is released from the internal energy, which is known as kinetic energy release (KER). KER is typically less than 1 eV, which is much smaller than the kinetic energy of the precursor ions. However, there is an amplification effect on changing coordinate systems from the center-of-mass to the lab frame. For ions with 1500 eV of kinetic energy (KE), the energy distribution after fragmentation can be 25 eV for a KER value of 0.1 eV and 80 eV for a KER value of 1.0 eV. At increased acceleration (such as 5,000 eV), this effect is reduced slightly relative to the KE, but the distribution can still be very wide. Thus, this fragment recoil can lead to significant broadening of the energies lowering the fragment spectrum resolution if only the KE is used to distinguish the different fragments. This effect can even become the dominating factor unless the angular distribution derived from the KER distribution is focused. The broadening effect of KER can be alleviated by the use of an energy analyzer that focuses the angular distribution and also by utilizing the correlation between flight time and KE. Examples of energy analyzers that focus angular distribution are electrostatic analyzer, cylindrical mirror analyzer, hemispherical mirror analyzer, and a cylindrical reflectron. A magnetic sector is a momentum analyzer that focuses angular distribution.

If both the flight time and kinetic energy are measured using a delay-line detector, the correlation between flight time and energy can be used to increase the energy resolution. An ion of mass M₁ and energy eV₀ has a velocity of

$${ν}_{1} = \sqrt{\frac{2 e {V}_{0}}{{M}_{1}}} \qquad ( 3 )$$

If M₁ fragments into masses of M₂ and M₃ (M₁⁺→M₂⁺+M₃) with a KER of ε, the velocity of M₂ becomes

$${ν}_{2} = {v}_{1} + {u}_{2} cos θ = \sqrt{\frac{2 e {V}_{0}}{{M}_{1}}} + \sqrt{\frac{2 {M}_{3} e ɛ}{{M}_{1} {M}_{2}}} cos θ \qquad ( 4 )$$

where θ is the fragmentation angle relative to the axis of ion travel and can range from 0 to 180 degrees.

In a preferred embodiment of the invention, a cylindrical reflectron is employed as a kinetic energy analyzer to focus the angular distribution of ions. The total TOF, to first order, is given by

$$TOF \approx \sqrt{\frac{{M}_{1}}{2 e {V}_{0}}} [ \begin{matrix}( A + 4 D \frac{{M}_{2}}{{M}_{1}} \frac{{V}_{0}}{{V}_{R}} ) - \\ \sqrt{\frac{{M}_{3}}{{M}_{2}} \frac{ɛ}{{V}_{0}}} cos θ ( A - 4 D \frac{{M}_{2}}{{M}_{1}} \frac{{V}_{0}}{{V}_{R}} )\end{matrix} ] \qquad ( 5 )$$

where V_{R} is the reflectron back plate voltage, A is the length of the field-free regions, and D is the length of the reflectron. Here, the first term is the TOF when KER is zero and the second term comes from the KER distribution. The first term shows a positive correlation between the TOF and energy of M₂=(M₂/M₁)V₀, because heavier fragments spend longer times in the reflectron. For a particular fragment (fixed M₂/M₁), there is a negative correlation between the TOF and cos θ, which is proportional to the KE.

FIG. 5 schematically shows two dimensional time of flight vs. kinetic energy data expected for a mixture of two precursor ions. Traces 502 and 504 are from the precursors, since precursors will have maximum kinetic energy and have negative intensities. Fragments corresponding to the precursor ion of trace 502 provide traces 502a-e, which all fall on curve 510. Similarly, fragments corresponding to the precursor ion of trace 504 provide traces 504a-e, which all fall on curve 520. There is a positive correlation between the TOF and the KE for the different fragments, but the slope is negative for each fragment, consistent with Eq. 5.

These opposite correlations allow different fragments to be differentiated with a higher resolution than could be obtained by only using kinetic energy information. More specifically, the fragment spectrum can be constructed from the curve along the centers of the fragment peaks. Because of the negative correlation for each fragment, the width of the fragment peak along the fragment spectrum curve can be much narrower than the KE width (e.g., 10 eV vs. 100 eV in one simulation). Additionally, some qualitative information about the KER distribution can be obtained by looking at the width of the peak perpendicular to the fragment spectrum. This information may be an added benefit to the technique providing an idea about the magnitude of the KER, which is related to dissociation mechanism. The slope of each fragment peak also contains the information about its mass, but at a lower resolution.

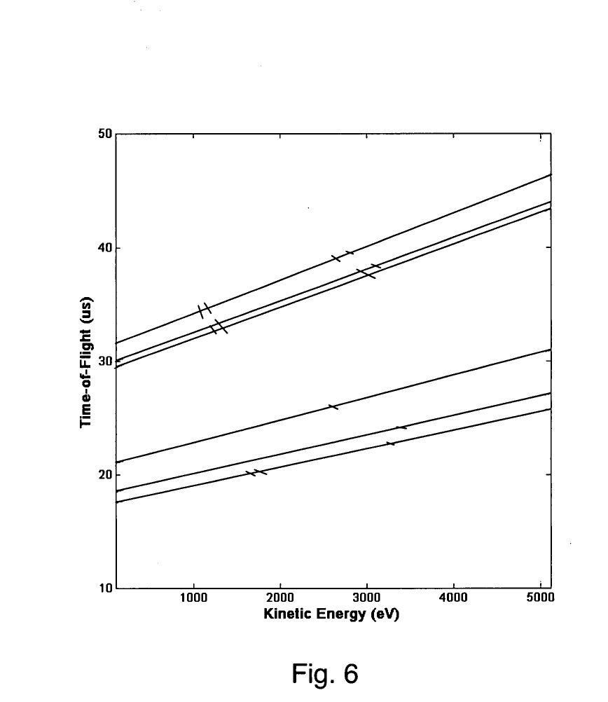

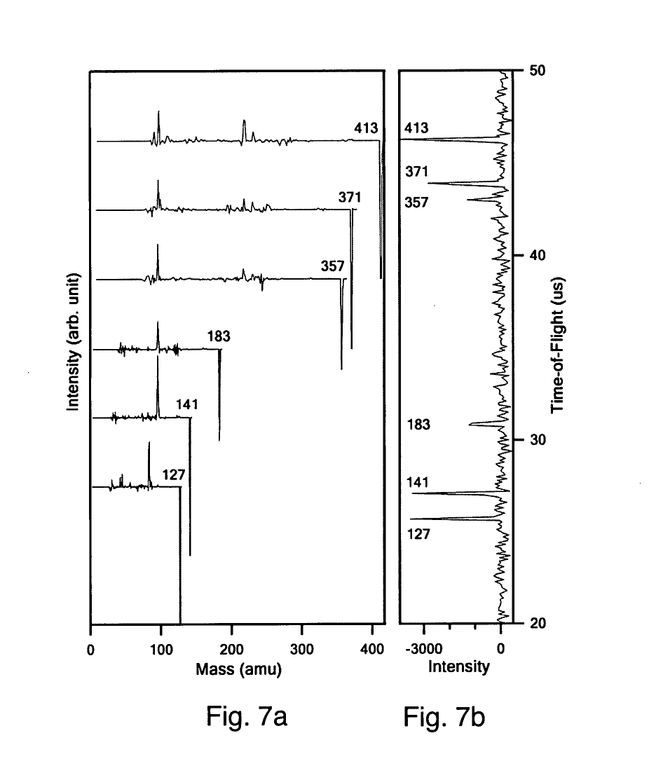

FIG. 6 is a simulation of time of flight vs. kinetic energy data provided by an embodiment of the invention. FIGS. 7a-b shows precursor and fragment mass spectra corresponding to the example of FIG. 6. In this example, a mixture of six imidazolium ionic liquids: C₆H₁₁N₂O⁺ (m/z 127), C₇H₁₃N₂O⁺ (m/z 141), C₁₀H₁₉N₂O⁺ (m/z 183), C₁₃H₁₄IN₂O₂⁺ (m/z 357), C₁₄H₁₆IN₂O₂⁺ (m/z 371), and C₁₇H₂₂IN₂O₂⁺ (m/z 413) was considered. Modulation at a 10 MHz modulation rate based on a Hadamard sequence of length 1023 was assumed. The ion energy was 5 keV. The fragmentation angles were assumed to have a random, isotropic direction. Ion arrival times were assumed to have a Poisson distribution. Fragmentation probabilities were based on published fragmentation spectra intensities, all fringe fields or imperfections in machining were ignored and only shot noise was assumed to exist in the baseline noise. A KER of 0.5 eV was assumed for all fragments.

The precursor ion spectrum at a KE of 5000 eV shows six negative-intensity peaks (FIG. 7b). These peaks are negative because precursor ions have been removed by dissociation according to the modulation sequence. From their flight times, the slopes of their corresponding fragment spectra can be calculated (the lines on FIG. 6). The qualitative features of the simulation results of FIG. 6 are consistent with the features shown on FIG. 5. FIG. 7a shows the fragment mass spectra of the six ionic liquids, obtained by reading out the two-dimensional data of FIG. 6 along the indicated lines. Note that the widths of the fragment mass peaks on FIG. 7a result from the intersections of the lines and traces on FIG. 6, which significantly reduces the adverse impact of KER on instrument resolution. Simulations of embodiments of the invention predict a resolution on the order of several hundred for fragment spectra, and 1,000 to 2,000 for precursor spectra.

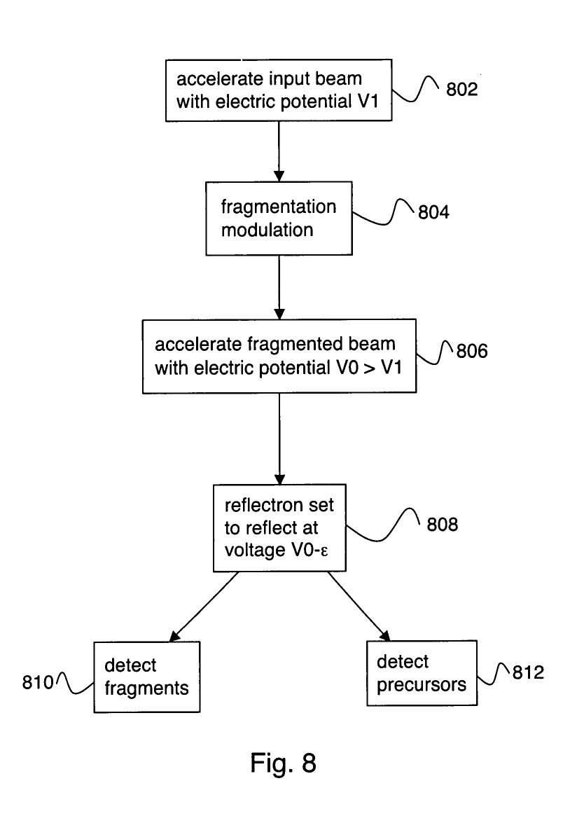

The preceding examples can be regarded as relating to an “imaging” mode, where 2-D data for TOF and energy or momentum is directly recorded by the detector. It is also possible to operate in a “scanning” mode, where ion kinetic energy or momentum is inferred from 1-D time of flight data by scanning an acceleration potential. For example, FIG. 8 shows a method for inferring ion kinetic energy information from time of flight measurements. Similar methods can also be employed for inferring ion momentum information from time of flight measurements.

In this method, the precursor ions are accelerated by eV₁ (802), fragmentation modulated (804), and then accelerated to eV₀ (806). Thus, the second acceleration causes the flight times to change differently for product ions of different masses. When eV₁ approaches eV₀, the product peaks converge toward their corresponding precursor ion peak positions. The backplate of the reflectron can be fixed at a voltage slightly smaller than V₀ (808), which causes all precursor ions to pass through the reflectron and be detected by a first detector (812), whereas all product ions follow a V-type trajectory and are detected by a second detector (810).

The flight time of a product ion of mass M₂ can be written as:

$${T}_{flight} ( {M}_{2} ) \approx D \sqrt{\frac{{M}_{1}}{2 e {V}_{0}}} / \sqrt{\frac{{V}_{1}}{{V}_{0}} + \frac{{M}_{2}}{{M}_{1}} ( 1 - \frac{{V}_{1}}{{V}_{0}} )} , \qquad ( 6 )$$

where D is the effective distance of the time-of-flight mass spectrometer. This equation can be rewritten as an effective mass including the calibration parameters a, b, and c,

$${M}_{eff} ( {V}_{1} ) = a {T}_{flight}^{2} + b {T}_{flight} + c = {M}_{1} / [ \frac{{V}_{1}}{{V}_{0}} + \frac{{M}_{2}}{{M}_{1}} ( 1 - \frac{{V}_{1}}{{V}_{0}} ) ] . \qquad ( 7 )$$

When V₁ is V₀, M_{eff} is equal to M₁, but M_{eff} approaches M₂ as V₁ is reduced to 0. The data analysis becomes more clear when the inverse of this equation is displayed,

$$\frac{1}{{M}_{eff}} = ( \frac{1}{{M}_{2}} - \frac{1}{{M}_{1}} ) \frac{{V}_{1}}{{V}_{0}} + \frac{1}{{M}_{1}} . \qquad ( 8 )$$

A plot of 1/M_{eff} as a function of V₁/V₀ gives a straight line with an intercept given by the inverse of the precursor ion mass and a slope related to the product ion mass. Thus, the inverse plot can be converted to a two-dimensional mass spectrum.

1. A method for performing mass spectrometry, the method comprising:
providing a substantially continuous beam of analyte ions;
decomposing said analyte ions into fragments, wherein an efficiency of said decomposing varies in time according to a beam modulation input, whereby a fragmentation modulated ion beam is provided corresponding to said modulation input;
analyzing said fragmentation modulated ion beam according to ion time of flight and according to either ion kinetic energy or ion momentum to provide a modulated ion spectrum;
applying a mathematical inversion corresponding to said modulation input to said modulated ion spectrum to provide a measured ion spectrum as an output.

2. The method of claim 1, wherein said measured ion spectrum comprises a two-dimensional spectrum of time of flight vs. either ion energy or ion momentum, obtained simultaneously for said fragments and for precursors of said fragments.

3. The method of claim 1, wherein said decomposing comprises passing a laser beam modulated according to said modulation input through said continuous beam of analyte ions.

4. The method of claim 1, wherein said decomposing comprises passing an electron beam modulated according to said modulation input through said continuous beam of analyte ions.

5. The method of claim 1, wherein said decomposing comprises deflecting said continuous beam of analyte ions onto or away from a surface induced dissociation target with an ion gate according to said modulation input.

6. The method of claim 5, wherein said ion gate comprises a Bradbury-Nielson gate.

7. The method of claim 1, wherein said analyzing comprises spatially separating said fragmented ion beam according to ion kinetic energy with an electrical ion analyzer.

8. The method of claim 1, wherein said analyzing comprises spatially separating said fragmented ion beam according to ion momentum with a magnetic ion analyzer.

9. The method of claim 1, wherein said analyzing comprises altering an ion acceleration potential applied to said continuous beam of analyte ions prior to said decomposing, whereby ion kinetic energy information or ion momentum information can be inferred from time of flight data.

10. The method of claim 1, wherein said modulation input is an analog signal.

11. The method of claim 1, wherein said modulation input is a digital signal.

12. The method of claim 11, wherein said digital signal comprises a Hadamard sequence.

13. A system for performing mass spectrometry, the system comprising:
an ion fragmentation apparatus which receives a substantially continuous beam of analyte ions and a beam modulation input signal, wherein an efficiency of decomposition of said analyte ions into fragments within said ion fragmentation apparatus varies in time according to said beam modulation input signal, whereby a fragmentation modulated ion beam corresponding to said modulation input signal is provided as an output from said ion fragmentation apparatus;
an ion separator which receives the fragmentation modulated ion beam and separates ions according to ion time of flight and according to either ion kinetic energy or ion momentum to provide a dispersed ion beam;
a detector, which receives said dispersed ion beam and provides a modulated ion spectrum;
a processor, wherein a mathematical inversion corresponding to said modulation input signal is applied to said modulated ion spectrum to provide a measured ion spectrum.

14. The system of claim 13, wherein said ion fragmentation apparatus comprises a laser beam modulated according to said modulation input signal, and wherein said laser beam intersects said continuous beam of analyte ions to provide said fragmentation modulated ion beam.

15. The system of claim 13, wherein said ion fragmentation apparatus comprises an electron beam modulated according to said modulation input signal, and wherein said electron beam intersects said continuous beam of analyte ions to provide said fragmentation modulated ion beam.

16. The system of claim 13, wherein said ion fragmentation apparatus comprises an ion gate modulated according to said modulation input signal, wherein said continuous beam of analyte ions is deflected onto or away from a surface induced dissociation target by said ion gate to provide said fragmentation modulated ion beam.

17. The system of claim 16, wherein said ion gate comprises a Bradbury-Nielson gate.

18. The system of claim 13, wherein said ion separator comprises an electrical ion analyzer for analyzing said fragmentation modulated ion beam according to ion kinetic energy.

19. The system of claim 13, wherein said ion separator comprises a magnetic ion analyzer for analyzing said fragmentation modulated ion beam according to ion momentum.
